(19) United States
(12) Patent Application Publication
(10) Pub. No.: US 2018/0122529 A1
(43) Pub. Date: May 3, 2018

(54) NANOCABLE AND MANUFACTURING METHOD THEREOF

(71) Applicant: 3C TAE YANG CO., LTD, Gangwon-do (KR)

(72) Inventors: Chang Soon HWANG, Seoul (KR); Sae Young AHN, Seoul (KR); Kyung Hee LEE, Seoul (KR)

(21) Appl. No.: 15/560,067

(22) PCT Filed: Sep. 24, 2015
(86) PCT No.: PCT/KR2015/010057

§ 371 Date: Sep. 20, 2017

(30) Foreign Application Priority Data
May 18, 2015 (KR) 10-2015-0068578

(51) Int. Cl. H01B 1/04; H01B 7/02; H01B 13/16; H01B 13/00; H01B 7/00; H01B 7/18

(52) U.S. Cl. CPC H01B 1/04; H01B 7/0216; H01B 7/18; H01B 13/0036; H01B 7/0009; H01B 13/16

(57) ABSTRACT

A nanocable in which the thickness of a core including a wire of first conductor is reduced and a layer of second conductor containing carbon nanotube is introduced, thereby achieving a cable having an ultrafine wire diameter and preventing current intensity from decreasing due to an increase in resistance because of the ultrafine wire diameter. The nanocable is configured such that a polymer layer (an insulating layer) is interposed between the core including a wire of first conductor and the layer of second conductor, thus preventing current intensity from decreasing due to an increase in resistance attributable to the ultrafine wire diameter while ensuring a cable having an external diameter ranging from ones of μm to hundreds of μm and having a nano-sized core diameter, whereby the nanocable can be utilized in medical instruments such as endoscopic tools.

### TECHNICAL FIELD

The present invention relates to a nanocable and, more particularly, to a nanocable and a method of manufacturing the same, in which the thickness of a core including a wire of first conductor is reduced, and a layer of second conductor containing carbon nanotube is introduced, thereby achieving a cable having an ultrafine wire diameter and preventing the current intensity from decreasing due to an increase in resistance attributable to the ultrafine wire diameter.

### BACKGROUND ART

With the recent drastic reduction in the sizes of medical instruments such as endoscopic tools, portable multi-media devices, etc., thorough research into drastically decreasing the wire diameter of cables for driving them and enhancing the performance thereof is ongoing.

For example, Korean Patent No. 10-0910431 discloses a fine coaxial cable having a diameter of 1 mm or less, comprising a central conductor formed of two or more fine metal wires, an insulating layer around the central conductor, a metal barrier layer formed in a spiral around the insulating layer using two or more flat-type metal wires, and a sheath layer around the metal barrier layer, wherein the metal wires for the metal barrier layer are formed in a flat shape to thus decrease the thickness of the metal barrier layer, so that the final wire diameter of the cable can be reduced (here, the term ‘final wire diameter’ refers to the total diameter of the cable including all the constituents, such as the central conductor, the insulating layer therearound and the like).

Meanwhile, as electronic devices are continuously required to be increasingly small, there is an increasing demand for cables that include a core (a central conductive wire) having a nano-sized diameter and have a final wire diameter ranging from ones of μm to hundreds of μm, which is much finer than conventional cables having a final wire diameter of less than ones of mm. Generally, when the conductive wire becomes thin, resistance may increase, undesirably leading to poor performance, for example low current intensity. Hence, limitations are imposed on the use of cables ranging in thickness from ones of μm to hundreds of μm in various application fields. Korean Patent No. 10-0910431 discloses only the barrier properties of the metal barrier layer, and does not propose solutions for preventing the current intensity from decreasing due to the increase in resistance because of the small wire diameter of the cables.

Meanwhile, carbon nanotube has a conductivity in a wide range from 10 to 10⁷ Ω/□, uniform and linear conductivity, high transparency, and low reflectivity, and may exhibit superior physical and electrical properties, including adhesion, durability, abrasion resistance, and bendability, and are a nanomaterial that is mainly used as a filler when forming a transparent conductive film for electrodes. In particular, since conductive carbon nanotube may range from very low surface resistance (10Ω/□) to very high surface resistance (10⁷ Ω/□), the surface resistance may be adjusted depending on the end use. Such carbon nanotube may have an affinity for a polymer, for example, polyethylene terephthalate (PET), epoxy, polycarbonate, polyethylene glycol, polymethyl methacrylate, and polyvinyl alcohol, as disclosed in the paper by Sertan Yesil et al. (Polymer Engineering & Science, Volume 51, Issue 7, Article first published online: 11 Feb. 2011).

Although the carbon nanotube has superior physical and electrical properties as described above, increasing the length thereof in the form of cable is technically difficult and the process therefor is complicated, making it difficult to use the carbon nanotube as a conductor for conventional coaxial cables.

### DISCLOSURE

### Technical Problem

Accordingly, the present invention has been made keeping in mind the above problems encountered in the related art, and an object of the present invention is to provide a nanocable, in which a polymer layer (an insulating layer) is interposed between a core including a wire of first conductor corresponding to a first conductive wire and a layer of second conductor corresponding to a second conductive wire, and in which the layer of second conductor includes carbon nanotube, thereby preventing the current intensity from decreasing due to an increase in resistance because of the ultrafine wire diameter while realizing a cable having a final wire diameter ranging from ones of μm to hundreds of μm and a nano-sized core diameter.

Another object of the present invention is to provide a method of manufacturing the nanocable, which includes passing a core through each of a polymer-containing solution and a second conductor-containing solution, thus forming a polymer layer (an insulating layer) and a layer of second conductor, thereby simplifying the production process and preventing the current intensity from decreasing due to an increase in resistance because of the ultrafine wire diameter.

### Technical Solution

In order to accomplish the above objects, an aspect of the present invention provides a nanocable, comprising: a core including at least one wire of first conductor, an insulating layer covering an outer surface of the core; and a layer of second conductor covering an outer surface of the insulating layer, in which the layer of second conductor includes carbon nanotube or graphene.

The at least one wire of first conductor may include at least one selected from the group consisting of copper, sodium, aluminum, magnesium, iron, nickel, cobalt, chromium, manganese, indium, tin, cadmium, palladium, titanium, gold, platinum, silver, graphene, and carbon nanotube.

The core may have a diameter of about 0.01 to about 1000 μm.

The insulating layer may include at least one polymer selected from the group consisting of polyethylene terephthalate (PET), polycarbonate (PC), polyethersulfone (PES), polyethylene naphthalate (PEN), polyester, acryl, cellulose, fluorocarbon, polyethylene, polypropylene, polybutadiene, polyacrylate, polyvinyl chloride, polyvinyl fluoride, polyamide, and polyurethane.

The insulating layer may include PET.

The insulating layer may have a thickness of about 0.01 to about 100 nm.

The layer of second conductor may include carbon nanotube.

The layer of second conductor may have a thickness of about 2 to about 20,000 nm.

The nanocable may further include a shield layer covering the outer surface of the layer of second conductor.

The nanocable may further include a jacket covering the outermost surface of the nanocable.

In addition, another aspect of the present invention provides a method of manufacturing a nanocable, comprising: passing a core including at least one wire of first conductor through a polymer-containing solution, thus forming a core covered with an insulating layer, and passing the core covered with the insulating layer through a second conductor-containing solution, thus forming a layer of second conductor on an outer surface of the insulating layer, in which the second conductor includes carbon nanotube or graphene.

The at least one wire of first conductor may include at least one selected from the group consisting of copper, sodium, aluminum, magnesium, iron, nickel, cobalt, chromium, manganese, indium, tin, cadmium, palladium, titanium, gold, platinum, silver, graphene, and carbon nanotube.

The polymer may include at least one selected from the group consisting of polyethylene terephthalate, polycarbonate, polyethersulfone, polyethylene naphthalate, polyester, acryl, cellulose, fluorocarbon, polyethylene, polypropylene, polybutadiene, polyacrylate, polyvinyl chloride, polyvinyl fluoride, polyamide, and polyurethane.

The polymer-containing solution may have a temperature of about 150 to about 400° C.

The method may further include cooling the core covered with the insulating layer to a temperature of less than about 150° C. before the passing the core covered with the insulating layer through the second conductor-containing solution.

The insulating layer may have a thickness of about 0.01 to about 100 nm.

The second conductor may include carbon nanotube.

The second conductor-containing solution may have a temperature ranging from room temperature to about 80° C.

The second conductor-containing solution may include the second conductor dispersed in an amount of about 0.02 to about 0.5 mg/mL.

The layer of second conductor may have a thickness of about 2 to about 20,000 nm.

### Advantageous Effects

According to an aspect of the present invention, a nanocable is configured such that a polymer layer (an insulating layer) is interposed between a core including a wire of first conductor and a layer of second conductor corresponding to a second conductive wire, in which the layer of second conductor includes carbon nanotube, whereby the final wire diameter of the cable ranges from ones of μm to hundreds of μm, and the diameter of the core is nano-sized, and the current intensity can be prevented from decreasing due to an increase in resistance because of the ultrafine wire diameter. Therefore, the cable of the invention can be utilized in medical instruments such as endoscopic tools.

Also, according to another aspect of the present invention, a method of manufacturing the nanocable includes sequentially passing the core through a polymer-containing solution and then a second conductor-containing solution, thereby forming the insulating layer and the layer of second conductor, ultimately simplifying the production process and preventing the current intensity from decreasing due to an increase in resistance attributable to the ultrafine wire diameter.

### DESCRIPTION OF DRAWINGS

FIG. 1 schematically illustrates a nanocable according to an embodiment of the present invention;

FIG. 2 illustrates the structure of polyethylene terephthalate, useful for an insulating layer, according to an embodiment of the present invention;

FIG. 3 is a perspective view illustrating a nanocable according to an embodiment of the present invention;

FIG. 4 illustrates a schematic view and a scanning electron microscope (SEM) image of carbon nanotube (CNT) according to an embodiment of the present invention; and

FIG. 5 illustrates the transmittance of carbon nanotube (CNT) according to an embodiment of the present invention.

### MODE FOR INVENTION

Hereinafter, embodiments of the present invention are described in detail so as to be easily performed by those skilled in the art, with reference to the accompanying drawings. The present invention may, however, be embodied in many different forms and should not be construed as being limited to the embodiments set forth herein. In the drawings, portions not pertaining to the description of the invention are omitted in order to dearly explain the present invention. Throughout the description, similar reference numerals refer to similar elements.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept implied by the term to best describe the method he or she knows for carrying out the invention.

Throughout the description of the present invention, it will be further understood that the terms “comprises” and/or “comprising”, or “includes” and/or “including”, when used in this specification, specify the presence of any element, and other elements are not excluded but are further included, unless otherwise described.

Throughout the description of the present invention, the term “A and/or B” may refer to A or B, or A and B.

Hereinafter, a detailed description will be given of the present invention with reference to the appended drawings, but the present invention is not limited thereto.

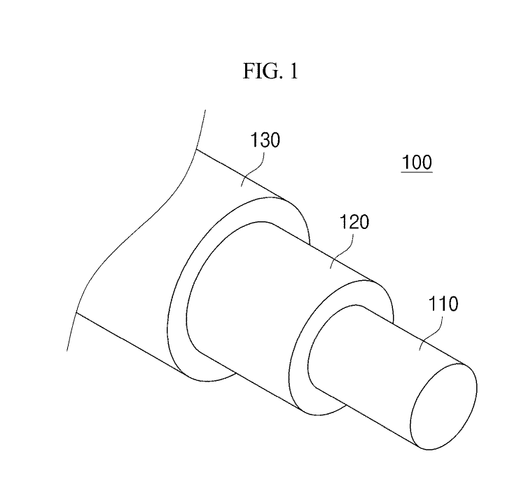

FIG. 1 schematically illustrates a nanocable according to an embodiment of the present invention.

As illustrated in FIG. 1, the nanocable 100 according to an embodiment of the present invention includes: a core 110 including at least one wire of first conductor, an insulating layer 120 covering the outer surface of the core; and a layer of second conductor 130 covering the outer surface of the insulating layer.

In an embodiment of the present invention, the at least one wire of first conductor, which is an internal conductive wire, may include at least one selected from the group consisting of copper, sodium, aluminum, magnesium, iron, nickel, cobalt, chromium, manganese, indium, tin, cadmium, palladium, titanium, gold, platinum, silver, graphene, and carbon nanotube. Typically, the at least one wire of first conductor may include, but is not limited to, copper or a copper alloy.

The core 110 may include a single wire of first conductor, or a plurality of wires of first conductor, and may be configured such that one wire or two or more wires of first conductor are stranded, but the present invention is not limited thereto. For example, the core may be formed by stranding a plurality of wires of first conductor.

In an embodiment of the present invention, the core may have a diameter of about 0.01 to about 1000 μm. For example, the diameter of the core may be about 0.01 to about 1000 μm, about 0.01 to about 800 μm, about 0.01 to about 600 μm, about 0.01 to about 400 μm, about 0.01 to about 300 μm, about 0.01 to about 200 μm, about 0.01 to about 100 μm, about 0.01 to about 80 μm, about 0.01 to about 60 μm, about 0.01 to about 40 μm, about 0.01 to about 20 μm, about 0.01 to about 10 μm, about 0.01 to about 1 μm, about 0.01 to about 0.5 μm, about 0.5 to about 1000 μm, about 1 to about 1000 μm, about 10 to about 1000 μm, about 20 to about 1000 μm, about 40 to about 1000 μm, about 60 to about 1000 μm, about 80 to about 1000 μm, about 100 to about 1000 μm, about 200 to about 1000 μm, about 400 to about 1000 μm, about 600 to about 1000 μm, about 800 to about 1000 μm, about 0.01 to about 100 nm, or about 50 to about 100 nm. If the diameter of the core exceeds about 1000 μm, it may be difficult to form a nanocable.

In the present invention, in order to enhance binding strength between the core including the wire of first conductor corresponding to the first conductive wire and the layer of second conductor corresponding to the second conductive wire, a polymer having an affinity for a carbon nanomaterial such as carbon nanotube or graphene may be used. In this regard, the paper by Sertan Yesil et al. discloses that carbon nanotube may have an affinity for polymers such as PET, epoxy, polycarbonate, polyethylene glycol, polymethylmethacrylate, and polyvinyl alcohol (Polymer Engineering & Science, Volume 51, Issue 7, Article first published online: 11 Feb. 2011). The polymer functions as an insulating layer.

The insulating layer 120, which covers the outer surface of the core 110, may include at least one polymer selected from the group consisting of polyethylene terephthalate, polycarbonate, polyethersulfone, polyethylene naphthalate, polyester, acryl, cellulose, fluorocarbon, polyethylene, polypropylene, polybutadiene, polyacrylate, polyvinyl chloride, polyvinyl fluoride, polyamide, and polyurethane. The insulating layer may include any one or a combination of two or more among the polymers listed as above.

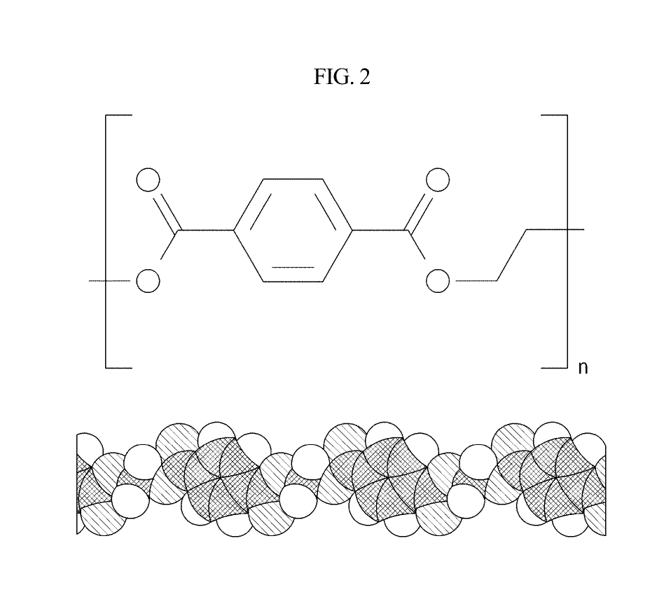

For example, the insulating layer may include, but is not limited to, PET. FIG. 2 illustrates the structure of PET for use in the insulating layer according to an embodiment of the present invention. With reference to FIG. 2, PET includes a large amount of oxygen, which is able to hold negative charges. Such oxygen functions as a bonding site that allows for bonding with carbon nanotube or graphene. PET is a semicrystalline thermoplastic polymer and has superior chemical resistance, thermal stability, melt mobility and spinnability, and is thus very useful in a variety of fields, including composite materials and packaging materials, and in the electrical, fiber, vehicle and construction industries.

In an embodiment of the present invention, the insulating layer may have a thickness of about 0.01 to about 100 nm. For example, the thickness of the insulating layer may be about 0.01 to about 100 nm, about 0.01 to about 80 nm, about 0.01 to about 50 nm, about 0.01 to about 30 nm, about 0.01 to about 10 nm, about 0.01 to about 5 nm, about 0.01 to about 1 nm, about 0.01 to about 0.5 nm, about 0.01 to about 0.1 nm, about 0.1 to about 100 nm, about 0.5 to about 100 nm, about 1 to about 100 nm, about 5 to about 100 nm, about 10 to about 100 nm, about 30 to about 100 nm, about 50 to about 100 nm, or about 80 to about 100 nm. If the thickness of the insulating layer exceeds about 100 nm, it may be difficult to form a nanocable. The formation of the nanocable requires that the thickness of the insulating layer be decreased. However, if the thickness of the insulating layer is less than about 0.01 nm, the allowable current that flows through the cable may decrease, or dielectric breakdown strength may decrease, undesirably deteriorating electrical reliability.

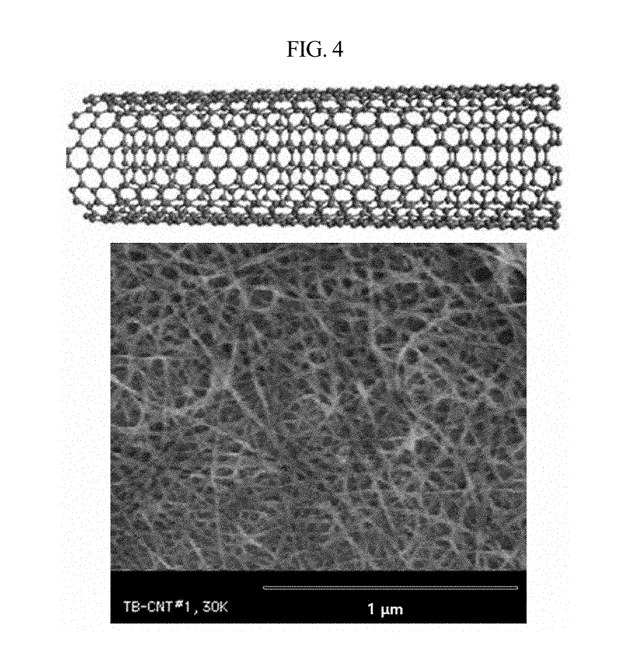

In an embodiment of the present invention, the layer of second conductor 130, which covers the outer surface of the insulating layer 120, may include, but is not limited to, carbon nanotube or graphene. Graphene is a thin film nanomaterial configured such that six-membered carbon rings are repeatedly arranged in a honeycomb shape. Here, the graphene may be a graphene sheet including a single layer or a stack of about 50 layers or less. As the number of layers of the graphene sheet is adjusted, the thickness of the layer of second conductor may be controlled. As for graphene, the number of layers may affect transparency, conductivity, and oxygen barrier effects, and thus the number of layers of graphene is adjusted to obtain the required thickness. Carbon nanotube is a carbon allotrope of graphene, and when viewed may appear to have the form of graphene wound in a cylindrical shape, but may actually have a spiral twisted structure, and are a nanomaterial quite different from graphene (FIG. 4). In the present invention, carbon nanotube may include, but are not limited to, a carbon nanotube network that is self-assembled on the outer surface of the insulating layer 120.

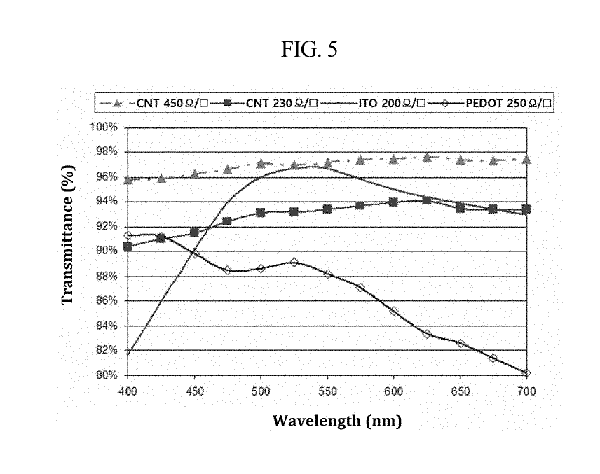

FIG. 5 illustrates the transmittance of CNT according to an embodiment of the present invention. With reference to FIG. 5, indium tin oxide (ITO) and poly(3,4-ethylmedioxythiophene) (PEDOT; a nonmetal conductive polymer), which are known to be conductors having electrical/physical properties similar to those of carbon nanotube, may show a transmittance of 90% or more in a limited wavelength range, whereas carbon nanotube may exhibit a high transmittance of 90% or more in the overall visible wavelength range (from 400 nm to 700 nm), and the transmittance may be slightly increased with an increase in the wavelength (90% or more: 230 Ω/□, 95% or more: 450Ω/□). Hence, in the present invention, the layer of second conductor preferably contains carbon nanotube.

In an example, the surface of carbon nanotube or graphene may be subjected to chemical treatment. The term “chemical treatment” refers to surface functionalization using a variety of chemical materials, and also to the surface modification of the carbon nanotube or graphene. Such surface modification may include covalent bond-type surface modification and non-covalent bond-type surface modification, and enables a variety of functional groups to be introduced to the surface of carbon nanotube or graphene. Covalent bond-type surface modification is a process of breaking sp² hybridization of the surface of carbon nanotube or graphene through a chemical reaction such as an oxidation reaction, addition reaction, or fluorination reaction, and non-covalent bond-type surface modification is a process of introducing an amphiphilic molecule or polymer to the hydrophobic surface without breaking the electron structure of the surface of carbon nanotube or graphene. For example, the carbon nanotube or graphene may be surface-modified using a functional group, such as a hydroxyl group, carboxyl group, halogen group, amino group, amine group, amide group, thiol group, nitro group, ketone group, sulfonic acid group, or phosphoric acid group, or may be surface-modified using sulfuric acid, nitric acid, phosphoric acid, acetic acid, sodium dodecyl sulfate (SDS), polyethylene glycol (PEG), bisphenol A diglycidyl ether (DGEBA), polyvinyl pyrrolidone, polyaniline, polyacrylic acid, and poly(4-styrenesulfonate). The carbon nanotube or graphene surface-modified as described above and the oxygen-containing polymer, such as PET, may be chemically binded to each other by virtue of strong binding strength.

For example, when the functionalized or surface-modified carbon nanotube or graphene are introduced to the layer of second conductor, the insulating layer 120 and the layer of second conductor 130 may form a strong bond, thus preventing the layer of second conductor from being stripped during harness processing.

The carbon nanotube or graphene may be subjected to ball milling, but the present invention is not limited thereto.

In an embodiment of the present invention, the thickness of the layer of second conductor 130 may range from about 2 to about 20,000 nm, but the present invention is not limited thereto. For example, the thickness of the layer of second conductor 130 may be about 2 to about 20,000 nm, about 2 to about 10,000 nm, about 2 to about 2000 nm, about 2 to about 1000 nm, about 2 to about 800 nm, about 2 to about 600 nm, about 2 to about 400 nm, about 2 to about 200 nm, about 2 to about 100 nm, about 2 to about 80 nm, about 2 to about 60 nm, about 2 to about 40 nm, about 2 to about 20 nm, about 2 to about 10 nm, about 2 to about 5 nm, about 5 to about 20,000 nm, about 10 to about 20,000 nm, about 20 to about 20,000 nm, about 40 to about 20,000 nm, about 60 to about 20,000 nm, about 80 to about 20,000 nm, about 100 to about 20,000 nm, about 200 to about 20,000 nm, about 400 to about 20,000 nm, about 600 to about 20,000 nm, about 800 to about 20,000 nm, about 1000 to about 20,000 nm, about 2 to about 50 nm, about 10 to about 50 nm, or about 30 to about 50 nm. If the thickness of the layer of second conductor exceeds about 20 μm (20,000 nm), transparency, conductivity, and oxygen barrier effects may deteriorate.

For example, when the layer of second conductor is composed of single-walled carbon nanotube, the layer of second conductor has a thickness of about 10 nm or less, and preferably about 2 nm. When the layer of second conductor is composed of multi-walled carbon nanotube, the layer of second conductor may have a thickness of about 10 μm (10,000 nm) or less.

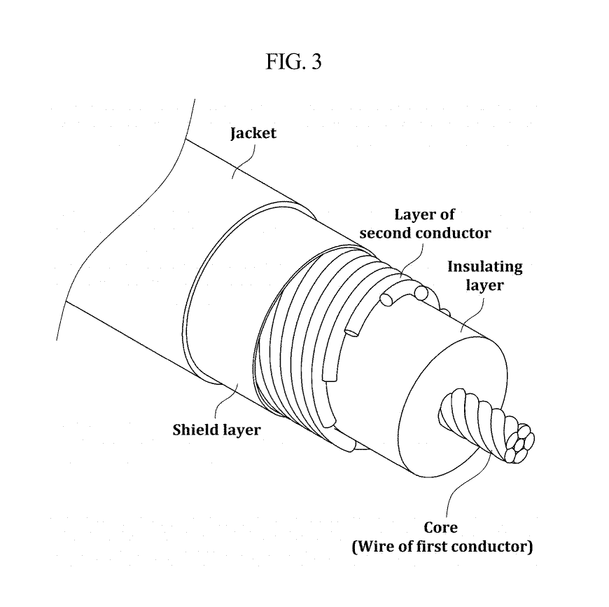

FIG. 3 is a perspective view illustrating a nanocable according to an embodiment of the present invention.

With reference to FIG. 3, the nanocable according to an embodiment of the present invention may further include a shield layer covering the outer surface of the layer of second conductor. The shield layer may include, but is not limited to, carbon nanotube, graphene, a copper alloy, or a conductive polymer that is highly flexible.

Also, the nanocable according to an embodiment of the present invention may further include a jacket covering the outermost surface of the nanocable. The jacket functions to protect the cable from external impacts, and may include a polymer, a polymer composite, a carbon nanomaterial, silicone, etc., which are typically useful in the art.

In addition, the present invention addresses a method of manufacturing the nanocable, including: passing a core including at least one wire of first conductor through a polymer-containing solution, thus forming a core covered with an insulating layer, and passing the core covered with the insulating layer through a second conductor-containing solution, thus forming a layer of second conductor on the outer surface of the insulating layer, in which the layer of second conductor includes carbon nanotube or graphene.

In an embodiment of the present invention, the at least one wire of first conductor may include at least one selected from the group consisting of copper, sodium, aluminum, magnesium, iron, nickel, cobalt, chromium, manganese, indium, tin, cadmium, palladium, titanium, gold, platinum, silver, graphene, and carbon nanotube. Typically, the at least one wire of first conductor may include, but is not limited to, copper or a copper alloy.

The core may comprise a single wire of first conductor or a plurality of wires of first conductor.

In an embodiment of the present invention, the core may be composed of one wire or two or more wires of first conductor that are stranded, but the present invention is not limited thereto. For example, the core may be formed by stranding a plurality of wires of first conductor.

In an embodiment of the present invention, the core may have a diameter of about 0.01 to about 1000 μm. For example, the diameter of the core may be about 0.01 to about 1000 μm, about 0.01 to about 800 μm, about 0.01 to about 600 μm, about 0.01 to about 400 μm, about 0.01 to about 300 μm, about 0.01 to about 200 μm, about 0.01 to about 100 μm, about 0.01 to about 80 μm, about 0.01 to about 60 μm, about 0.01 to about 40 μm, about 0.01 to about 20 μm, about 0.01 to about 10 μm, about 0.01 to about 1 μm, about 0.01 to about 0.5 μm, about 0.5 to about 1000 μm, about 1 to about 1000 μm, about 10 to about 1000 μm, about 20 to about 1000 μm, about 40 to about 1000 μm, about 60 to about 1000 μm, about 80 to about 1000 μm, about 100 to about 1000 μm, about 200 to about 1000 μm, about 400 to about 1000 μm, about 600 to about 1000 μm, about 800 to about 1000 μm, about 0.01 to about 100 nm, or about 50 to about 100 nm. If the diameter of the core exceeds about 1000 μm, it may be difficult to form the nanocable.

In the present invention, forming the core covered with the insulating layer includes passing the core including the wire of first conductor through the polymer-containing solution. Passing the core including the wire of first conductor through the polymer-containing solution may include placing the core in a reaction bath including the polymer-containing solution so that the core is immersed in the polymer-containing solution, but the present invention is not limited thereto. This process may be performed once or several times in order to achieve the thickness required for the insulating layer.

The polymer-containing solution may include a polymer melt, or a mixed solution of polymer and solvent. As the solvent, any solvent may be used without particular limitation so long as it is typically used in the art to dissolve or disperse the polymer.

In an embodiment of the present invention, the polymer may include at least one selected from the group consisting of PET, polycarbonate, polyethersulfone, polyethylene naphthalate, polyester, acryl, cellulose, fluorocarbon, polyethylene, polypropylene, polybutadiene, polyacrylate, polyvinyl chloride, polyvinyl fluoride, polyamide, and polyurethane. The polymer may include any one or a combination of two or more among the polymers listed as above. For example, the insulating layer may include, but is not limited to, PET.

In an embodiment of the present invention, the temperature of the polymer-containing solution may be, but is not limited to, about 150 to about 400° C. For example, the temperature of the polymer-containing solution may be about 150 to about 400° C., about 150 to about 350° C., about 150 to about 300° C., about 150 to about 250° C., about 150 to about 200° C., about 200 to about 400° C., about 250 to about 400° C., about 300 to about 400° C., or about 350 to about 400° C.

The temperature of the polymer-containing solution may be set in the range of about 150° C. or higher, taking into consideration the melting point of the polymer. For example, PET may be melted at about 250° C., and thus the temperature of the solution thereof is preferably set to 250° C. or higher.

In an embodiment of the present invention, the method of manufacturing the nanocable may further include cooling the core covered with the insulating layer to a temperature of less than about 150° C. before passing it through the second conductor-containing solution. When the core covered with the insulating layer is cooled to a temperature of less than about 150° C., the covered polymer may become hard, thus facilitating subsequent processing (covering with the layer of second conductor) thereon. As such, the cooling temperature may fall in the range of room temperature to about 150° C., room temperature to about 100° C., room temperature to about 50° C., about 50° C. to less than about 150° C., or about 100° C. to less than about 150° C.

In an embodiment of the present invention, the formed insulating layer may have a thickness of about 0.01 to about 100 nm. For example, the thickness of the insulating layer may be about 0.01 to about 100 nm, about 0.01 to about 80 nm, about 0.01 to about 50 nm, about 0.01 to about 30 nm, about 0.01 to about 10 nm, about 0.01 to about 5 nm, about 0.01 to about 1 nm, about 0.01 to about 0.5 nm, about 0.01 to about 0.1 nm, about 0.1 to about 100 nm, about 0.5 to about 100 nm, about 1 to about 100 nm, about 5 to about 100 nm, about 10 to about 100 nm, about 30 to about 100 nm, about 50 to about 100 nm, or about 80 to about 100 nm. If the thickness of the insulating layer exceeds about 100 nm, it may be difficult to form the nanocable. The formation of the nanocable requires that the thickness of the insulating layer be decreased. However, if the thickness of the insulating layer is less than about 0.01 nm, the allowable current that flows through the cable may decrease, or dielectric breakdown strength may decrease, undesirably deteriorating electrical reliability.

In the present invention, forming the layer of second conductor on the outer surface of the insulating layer includes passing the core covered with the insulating layer through the second conductor-containing solution. Passing the core covered with the insulating layer through the second conductor-containing solution may include placing the core covered with the insulating layer in a reaction bath including the second conductor-containing solution so that it is immersed in the second conductor-containing solution, but the present invention is not limited thereto. This process may be performed once or several times in order to achieve the thickness required for the layer of second conductor.

The second conductor-containing solution may be obtained by dispersing the second conductor in a solvent. The solvent may include at least one selected from the group consisting of water, butylamine, hexylamine, triethylamine, pyridine, pyrazine, pyrrole, methylpyridine, methanol, ethanol, trifluoroethanol, propanol, isopropanol, terpineol, tetrahydrofuran, dichloromethane, 1,2-dichloroethane, 1,2-dichlorobenzene, chloroform, cyclohexanone, toluene, 1,4-dioxane, acetone, ethylacetate, butylacetate, methyl methacrylate, ethyleneglycol, hexane, dimethylformamide, dimethylacetamide, dimethylsulfoxide, methylethylketone, methyl isobutylketone, butyl cellosolve, butyl cellosolve acetate, and N-methyl-pyrrolidone.

In an embodiment of the present invention, the second conductor may include, but is not limited to, carbon nanotube or graphene. Graphene is a thin film nanomaterial configured such that six-membered carbon rings are repeatedly arranged in a honeycomb shape. Graphene may be a graphene sheet comprising a single layer or a stack of about 50 layers or less. The number of layers of the covering graphene sheet is adjusted in a manner in which the core covered with the insulating layer is passed through the second conductor-containing solution one or more times, whereby the thickness required for the layer of second conductor may be ensured. Carbon nanotube is a carbon allotrope of graphene, and may have the appearance of graphene that is wound in a cylindrical shape, but actually have a spiral twisted structure, and are a different nanomaterial from graphene. In the present invention, the core covered with the insulating layer may be passed through the second conductor-containing solution one or more times, whereby the carbon nanotube may self-assemble on the outer surface of the insulating layer and the thickness required for the layer of second conductor may be attained. The layer of second conductor preferably includes carbon nanotube.

In an example, the surface of carbon nanotube or graphene may be subjected to chemical treatment. The carbon nanotube or graphene, functionalized or surface-modified as described above, and the oxygen-containing polymer, such as PET, may be chemically binded to each other by virtue of strong binding strength, and may be more uniformly dispersed in the solvent.

For example, when the functionalized or surface-modified carbon nanotube or graphene are introduced to the layer of second conductor, the insulating layer and the layer of second conductor may form a strong bond, thus preventing the layer of second conductor from being stripped during hardness processing.

The carbon nanotube or graphene may be subjected to ball milling before mixing with the solvent, but the present invention is not limited thereto.

In an embodiment of the present invention, the second conductor-containing solution may be obtained by uniformly dispersing the second conductor in the solvent using ultrasonic waves or magnetic force, but the present invention is not limited thereto.

In the second conductor-containing solution, the second conductor may be dispersed in an amount of about 0.02 to about 0.5 mg/mL. If the amount of the second conductor dispersed in the second conductor-containing solution exceeds about 0.5 mg/mL, dispersibility may deteriorate, and thus the resulting layer of second conductor may have a non-uniform thickness, and protrusions may be undesirably formed.

The temperature of the second conductor-containing solution may range from room temperature to about 80° C. The preferred temperature of the second conductor-containing solution is lower than the melting point of the polymer, for example, room temperature to about 80° C., room temperature to about 70° C., room temperature to about 60° C., room temperature to about 50° C., about 50° C. to about 80° C., about 60° C. to about 80° C., or about 70° C. to about 80° C. If the temperature for forming the layer of second conductor is lower than room temperature, the cost may undesirably increase owing to excessive cooling. On the other hand, in the case where the temperature therefor is higher than about 150° C., the polymer for the insulating layer may be melted, making it difficult to form the layer of second conductor on the surface thereof.

In an embodiment of the present invention, the formed layer of second conductor may have, but is not limited to, a thickness of about 2 to about 20,000 nm. For example, the thickness of the layer of second conductor may be about 2 to about 20,000 nm, about 2 to about 10,000 nm, about 2 to about 2000 nm, about 2 to about 1000 nm, about 2 to about 800 nm, about 2 to about 600 nm, about 2 to about 400 nm, about 2 to about 200 nm, about 2 to about 100 nm, about 2 to about 80 nm, about 2 to about 60 nm, about 2 to about 40 nm, about 2 to about 20 nm, about 2 to about 10 nm, about 2 to about 5 nm, about 5 to about 20,000 nm, about 10 to about 20,000 nm, about 20 to about 20,000 nm, about 40 to about 20,000 nm, about 60 to about 20,000 nm, about 80 to about 20,000 nm, about 100 to about 20,000 nm, about 200 to about 20,000 nm, about 400 to about 20,000 nm, about 600 to about 20,000 nm, about 800 to about 20,000 nm, about 1000 to about 20,000 nm, about 2 to about 50 nm, about 10 to about 50 nm, or about 30 to about 50 nm. If the thickness of the layer of second conductor exceeds about 20 μm, transparency, conductivity, and oxygen barrier effects may deteriorate.

The method of manufacturing the nanocable according to the embodiment of the present invention may further include forming a shield layer on the outer surface of the layer of second conductor, and may also include forming a jacket on the outer surface of the shield layer after forming the shield layer.

Forming the shield layer or forming the jacket may be carried out using a covering process typically known in the art.

The shield layer may include carbon nanotube, graphene, a copper alloy, or a conductive polymer that is highly flexible, and the jacket may include a polymer, a polymer composite, a carbon nanomaterial, silicone, etc., which are typically useful in the art, but the present invention is not limited thereto.

As described hereinbefore, the description of the present invention is illustrative, and those skilled in the art will appreciate that the present invention may be embodied in other specific ways without changing the technical spirit or essential features thereof. Therefore, the embodiments of the present invention are intended to be illustrative in all aspects and are to be understood as non-limiting. For example, each constituent described as having the form of a single piece may be distributed, and constituents that are described as being distributed may also be embodied in combination.

The scope of the present invention is represented by the following claims, rather than the detailed description, and it is to be construed that the meaning and scope of the claims and all variations or modified forms derived from the equivalent concept thereof are encompassed within the scope of the present invention.

1: A nanocable, comprising:
a core including at least one wire of a first conductor;
an insulating layer covering an outer surface of the core; and
a layer of a second conductor covering an outer surface of the insulating layer,
wherein the layer of the second conductor includes carbon nanotube or graphene.

2: The nanocable of claim 1, wherein the at least one wire of the first conductor includes at least one selected from the group consisting of copper, sodium, aluminum, magnesium, iron, nickel, cobalt, chromium, manganese, indium, tin, cadmium, palladium, titanium, gold, platinum, silver, graphene, and carbon nanotube.

3: The nanocable of claim 1, wherein the core has a diameter of 0.01 to 1000 μm.

4: The nanocable of claim 1, wherein the insulating layer includes at least one polymer selected from the group consisting of polyethylene terephthalate, polycarbonate, polyethersulfone, polyethylene naphthalate, polyester, acryl, cellulose, fluorocarbon, polyethylene, polypropylene, polybutadiene, polyacrylate, polyvinyl chloride, polyvinyl fluoride, polyamide, and polyurethane.

5: The nanocable of claim 1, wherein the insulating layer includes polyethylene terephthalate.

6: The nanocable of claim 1, wherein the insulating layer has a thickness of 0.01 to 100 nm.

7: The nanocable of claim 1, wherein the layer of the second conductor includes carbon nanotube.

8: The nanocable of claim 1, wherein the layer of the second conductor has a thickness of 2 to 20,000 nm.

9: The nanocable of claim 1, further comprising a shield layer covering an outer surface of the layer of the second conductor.

10: The nanocable of claim 1, further comprising a jacket covering an outermost surface of the nanocable.

11: A method of manufacturing a nanocable, comprising:
passing a core including at least one wire of a first conductor through a polymer-containing solution, thus forming a core covered with an insulating layer; and
passing the core covered with the insulating layer through a second conductor-containing solution, thus forming a layer of the second conductor on an outer surface of the insulating layer,
wherein the second conductor includes carbon nanotube or graphene.

12: The method of claim 11, wherein the at least one wire of the first conductor includes at least one selected from the group consisting of copper, sodium, aluminum, magnesium, iron, nickel, cobalt, chromium, manganese, indium, tin, cadmium, palladium, titanium, gold, platinum, silver, graphene, and carbon nanotube.

13: The method of claim 11, wherein the polymer includes at least one selected from the group consisting of polyethylene terephthalate, polycarbonate, polyethersulfone, polyethylene naphthalate, polyester, acryl, cellulose, fluorocarbon, polyethylene, polypropylene, polybutadiene, polyacrylate, polyvinyl chloride, polyvinyl fluoride, polyamide, and polyurethane.

14: The method of claim 11, wherein the polymer-containing solution has a temperature of 150 to 400° C.

15: The method of claim 11, further comprising cooling the core covered with the insulating layer to a temperature of less than 150° C. before the passing the core covered with the insulating layer through the second conductor-containing solution.

16: The method of claim 11, wherein the insulating layer has a thickness of 0.01 to 100 nm.

17: The method of claim 11, wherein the second conductor includes carbon nanotube.

18: The method of claim 11, wherein the second conductor-containing solution has a temperature ranging from room temperature to 80° C.

19: The method of claim 11, wherein the second conductor-containing solution includes the second conductor dispersed in an amount of 0.02 to 0.5 mg/mL.

20: The method of claim 11, wherein the layer of the second conductor has a thickness of 2 to 20,000 nm.
